(19) United States
(12) Patent Application Publication
(10) Pub. No.: US 2010/0250654 A1
(43) Pub. Date: Sep. 30, 2010

(54) Contents distributed storage system, web page creating method, server device, and computer-readable recording medium in which server processing program is recorded

(75) Inventor: Tadashi Hirano, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/659,301

(22) Filed: Mar. 3, 2010

(30) Foreign Application Priority Data
Mar. 30, 2009 (JP) 2009-083288

(51) Int. Cl. G06F 15/16

(52) U.S. Cl. 709/203

(57) ABSTRACT

A server device which can communicate with a node device in a contents distributed storage system stores contents attribute information obtained from a predetermined device which stores the contents attribute information, and creates a Web page in which the contents attribute information is inserted. A node device receive a page request of a Web page from any of node devices, and transmits the created Web page, to a node device which has transmitted the page request, in accordance with the page request.

### CROSS REFERENCE TO RELATED APPLICATION

The present application claims priority from Japanese Patent Application No. 2009-83288, which was filed on Mar. 30, 2009, the disclosure of which is incorporated herein by reference in its entirety.

### BACKGROUND OF THE INVENTION

1. Field of the Invention

The present invention relates to a technical field of a communication system of a Peer-to-Peer (P2P) type which comprises a plurality of node devices which can communicate with each other through a network.

2. Discussion of Related Art

In this kind of communication system of a Peer-to-Peer type, a contents distributed storage system is known, in which contents data are distributed and stored in a plurality of node devices. In a communication system of a Peer-to-Peer type, it is possible to reduce a load of server caused due to the concentration of accesses to a server, which is a defect in a communication system of a client-server type.

The location of contents data thus distributed and stored can be retrieved effectively by utilizing a Distributed Hash Table (hereinafter, referred to as “DHT”) disclosed in a related art.

### SUMMARY OF THE INVENTION

In recent year, a system is proposed, in which contents of moving images are public to a general user on a Web site by utilizing such contents distributed storage system. On a Web page of such system, the titles of contents, and contents IDs uniquely assigned to the respective moving-image contents are incorporated. Thus, a browser of each node device can display a Web page on which the titles of contents are displayed in a selectable manner. When the titles of contents thus displayed on a Web page are selected by a user, a node device retrieves contents data, as disclosed in the related art. In the case of retrieval of contents data, a query which includes a contents ID corresponding to the selected title of contents is transmitted to another node device. A node device can obtain and playback retrieved contents data.

In a contents distributed storage system of a Peer-to-Peer type mentioned above, in principle, a plurality of contents data are distributed and stored in a plurality of node devices. As a back-up of contents data, there is a contents management server which manages all contents data.

In order to create a Web page for playing-back contents, for example, it is thought that a Web server asks a contents management server about contents data. The Web server obtains contents attribute information including a contents ID, from the contents management server. After obtaining the contents attribute information, it is thought that the Web server reads contents attribute information in a Web page for dynamic creation.

In this case, however, a Web server asks a contents management server frequently. As a result, a reduction of load of sever which is a characterizing feature in a communication system of a Peer-to-Peer type is impaired.

The present invention has been accomplished in light of the above points and the like. It is an object of the present invention to provide a contents distributed storage system, a web page creating method, a server device, and a computer-readable recording medium in which a server processing program is recorded, being capable of dynamically creating and transmitting to a node device a Web page for playing-back contents, without impairing a reduction of load of server.

In order to solve the above problem, according to the invention according to claim 1, there is provided a server device which can communicate with a node device in a contents distributed storage system in which a plurality of contents data are distributed and stored in a plurality of node devices which can communicate with each other through a network, and in which each node device stores contents attribute information necessary for retrieving the locations of the contents data,

the server device comprising:

a storage device configured to store contents attribute information obtained from a predetermined device which stores the contents attribute information,

a creating device configured to create a Web page in which the contents attribute information stored in the storage device is inserted,

a receiving device configured to receive a page request of a Web page from any of the node devices, and

a transmission device configured to transmit the Web page created by the creating device, to the node device which has transmitted the request, based on the page request received by the receiving device.

### BRIEF DESCRIPTION OF THE DRAWINGS

FIG. 1 is a conceptual view illustrating an example of a schematic structure of a contents distributed storage system according to the present embodiment.

FIG. 2 is a view illustrating an example of contents attribute information described in contents catalogue information.

FIG. 3 is a view illustrating an example of a schematic structure of a Web server WS.

FIG. 4A is a flow chart illustrating an example of a process at the side of a Web server unit WS1, and FIG. 4B is a flow chart illustrating an example of a process at the side of a node unit WS2.

FIG. 5A is a view illustrating an example of HTML data describing a Web page created by a Web server unit WS1, and FIG. 5B is a view illustrating an example of screen on which the Web page is displayed (browsed) by a browser of a node Nn.

FIG. 6A is a view illustrating an example of HTML data describing a Web page changing at the time when the title of contents “ABCD” displayed on a Web page shown in FIG. 5B is selected, and FIG. 6B is a view illustrating an example of screen at the time when the Web page is displayed (browsed) by a browser of a node Nn.

### DESCRIPTION OF THE PREFERRED EMBODIMENT

Referring now to the drawings, the preferred embodiment of the invention will be described. The following embodiment is an embodiment in which the present invention is applied to a contents distributed storage system.

### [1. Schematic Structure and Operation of Contents Distributed Storage System]

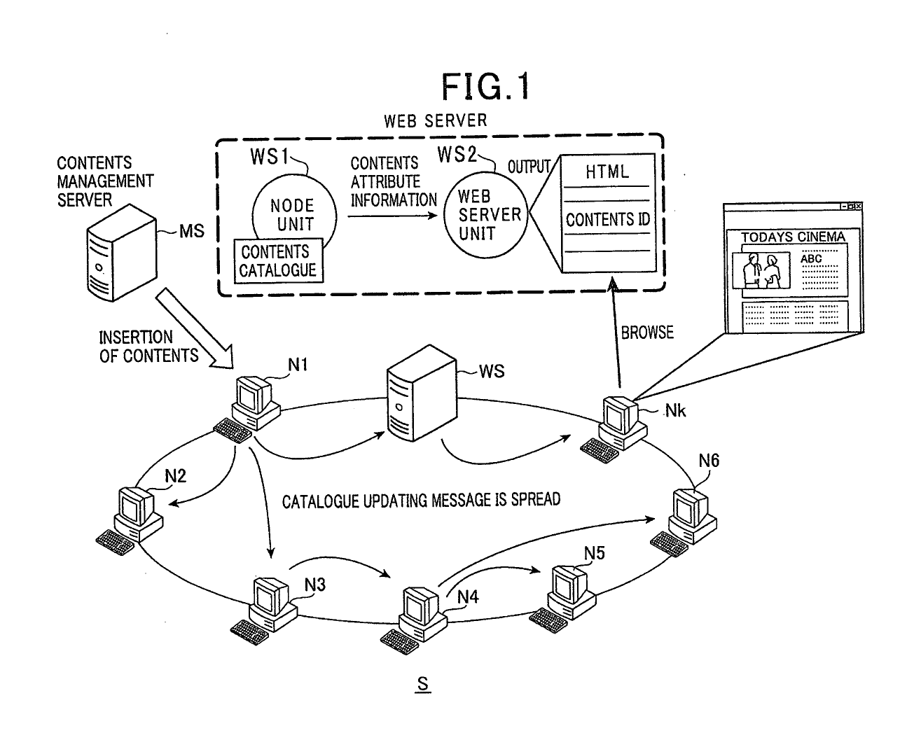

First, referring to FIG. 1 and the like, an outline of a structure and an operation of a contents distributed storage system according to the present embodiment will be described.

As shown in FIG. 1, a contents distributed storage system S according to the present embodiment is arranged by participation of a plurality of node devices (hereinafter, referred to as “a node”) Nn (n=any of 1, 2, 3, - - - ) connected to a network such as an Internet and being capable of communicating with each other. The contents distributed storage system S is a network system of a Peer-to-Peer method. As a node Nn, a personal computer or the like which has a browser function of displaying a Web page is used.

In the contents distributed storage system S, a Web server WS which can communicate with a node Nn connected to the above network is provided. The Web server WS is an example of a server device according to the present invention. The Web server WS has a processing function of Web server of transmitting a Web page to a node Nn, and a processing function of node Nn. That is, the Web server WS can function as one node which participates in a contents distributed storage system S, by making a processing function of a node Nn stay resident. In the following description, in a Web server WS, a unit in charge of a processing function of a Web server is referred to as “a web server unit WS1”. In a Web server WS, a unit in charge of a processing function of a node Nn is referred to as “a node unit WS2”.

To each node Nn and a node unit WS2, a node ID which is an inherent identification data with a predetermined number of digits is assigned. The node ID is, for example, an IP address assigned to each node Nn separately, or a value obtained by hashing a manufacturing number with a common hash function. The node IDs are distributed and arranged in an ID space in a balanced fashion. In the present embodiment, SHA-1 is used as a hash function. Concerning a hashed value, a bit length is, for example, 160 bit.

Each node Nn and a node unit WS2 hold a routing table using DHT, respectively. The routing table prescribes destinations to which a variety of messages are to be transmitted in a contents distributed storage system S. Specifically, a plurality of pieces of node information are stored, each of the pieces of node information including a node ID, an IP address, and a port number of node Nn which is appropriately apart in an ID space. A routing table in which such DHT is used is known in Japanese Patent Laid-open No. 2006-197400, and so on, so a detailed explanation thereof is omitted.

In a contents distributed storage system S, a variety of contents data whose contents are different from each other are distributed and stored in a plurality of nodes Nn in a predetermined file format. Contents data is, for example, data of a movie, a program, and so on.

To each of contents data, information such as a title of contents (title) and a contents ID is added. Hereinafter, contents data is referred to as “contents”. A contents ID is an identification data unique to each of contents. A contents ID is retrieval information for retrieving the location of contents. For example, a contents ID is created by hashing a title of contents and any value with a hash function common to a hash function used in obtaining the above node ID. Or, a contents ID is created by hashing a number of bytes in the heading of contents data with the above hash function. Or, a system manager may add a unique ID value to each of contents as a contents ID. A contents ID has the same bit length as a node ID. Index information is information indicative of the location of contents thus distributed and stored. That is, index information is information in which a set of node information of node Nn which stores contents, a contents ID of the contents, and the like is included. Hereinafter, a node Nn which stores contents is referred to as “a contents holding node”. Index information is arranged to be stored in an index cache, or managed, by a node Nn or the like which manages the location of contents. A node Nn which manages the location of contents is, hereinafter, referred to as “a root node”. Such root node is determined to be, for example, a node Nn which has a node ID closest to a contents ID. For example, a node ID closest to a contents ID is a node ID whose higher-order digits are more coincident with that of a contents ID.

In the case where a user of a node Nn desires to obtain desired contents, the node Nn creates a contents location asking message. A node Nn used for a user to obtain desired contents is, hereinafter, referred to as “a user node”. The contents location asking message is also, hereinafter, referred to as “a retrieval query”. The contents location asking message includes a contents ID of contents selected by a user, an IP address of a node device itself, and the like. The contents location asking message is transmitted to another node Nn in accordance with a routing table in which a DHT stored in a user node is used. That is, a user node transmits a contents location asking message toward a root node. Specifically, a user node transmits a contents location asking message to a root node. Thus, a contents position asking message finally reaches a root node by a DHT routing in which a contents ID is a key. A DHT routing is known in Japanese Patent Laid-open No. 2006-197400, and so on, and therefore, a detailed explanation thereof is omitted.

When a root node receives the above contents location asking message, the root node obtains index information corresponding to a contents ID included therein, from a index cache. The root node returns the obtained index information to a user node which has transmitted the received contents location asking message. In accordance with the above method, when a user node obtains index information, the user node accesses a contents holding node based on an IP address or the like of the contents holding node included in the obtained index information. Therefore, a user node can download and play back contents. Here, “downloading” is an example of “obtaining”.

A root node transmits a contents transmission request message to a contents holding node indicated by an IP address or the like included in the obtained index information. The contents transmission request message includes information indicative of the location of a user node in a network, and a contents ID of contents which the user node desires to obtain. The information indicative of the location of a user node in a network is, for example, an IP address or the like. The contents holding node can also access the user node to provide contents.

Thus, a user node transmits a contents location asking message including a contents ID, to another node Nn. Based on the message, the location of contents, i.e., a contents holding node which stores the contents is retrieved. A user node can obtain contents from the contents holding node.

All contents stored in a contents distributed storage system S is managed by a contents management server MS. The contents management server MS stores contents attribute information of all contents stored in the contents distributed storage system S. The contents management server MS distributes contents catalogue information in which the contents attribute information is described, to all nodes Nn, with a DHT multicast. The DHT multicast is disclosed in, for example, Japanese Patent Laid-open No. 2007-053662. In the DHT multicast, a message distributed to a certain node Nn from the contents management server MS is successively transmitted to a node Nn participating in the contents distributed storage system S in accordance with a routing table in which a DHT is used. Thus, the message is finally distributed to all nodes Nn.

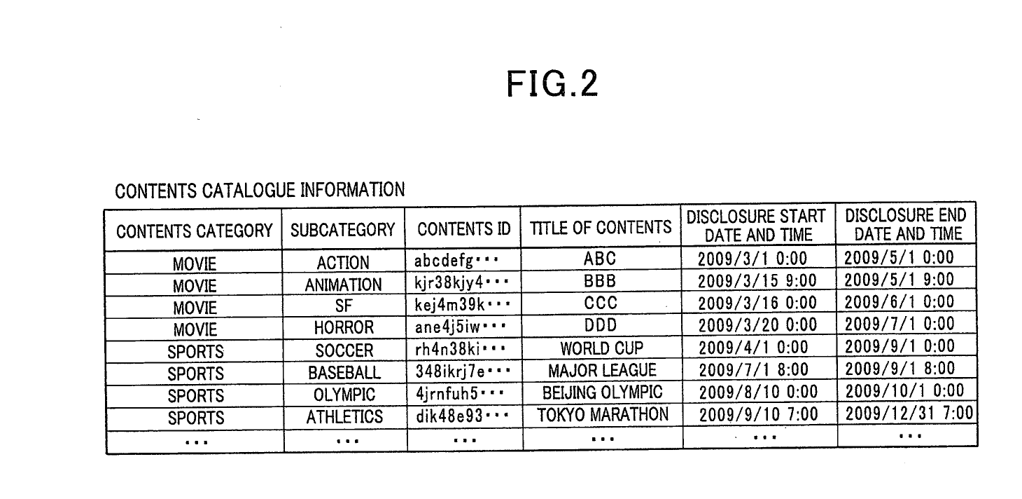

For example, assume that contents are newly introduced in a contents distributed storage system S. That is, this is a case where new contents are transmitted to, and stored in a node Nn. In this case, a contents updating message is distributed from a contents management server MS to all nodes Nn with a DHT multicast. The contents updating message includes contents catalogue information in which contents attribute information of new contents is described. A transmission process of contents updating message by such DHT multicast will be described. In the transmission process of contents updating message, a node unit WS2 of a Web server WS receives a contents updating message including contents catalogue information, from a contents management server MS or a node Nn. The node unit WS2 of the Web server WS obtains contents catalogue information. A contents updating message is also distributed from a contents management server MS with a DHT multicast, when contents are deleted from a contents distributed storage system S. In an example shown in FIG. 2, as contents attribute information, a contents category, a subcategory, or a contents ID necessary to retrieve the location of contents, and the title of contents, the date and time of start of disclosure, and the date and time of end of disclosure are described in contents catalogue information.

Here, a contents category, a subcategory, and the title of contents are used for a user to keyword-retrieve a contents ID of desired contents from contents catalogue information. A contents distributed storage system S is arranged to be incapable of retrieving and obtaining the location of contents using a contents ID during a period of time other than a disclosure period of time from the date and time of start of disclosure to the date and time of end of disclosure. Therefore, even if a contents ID is retrieved from contents catalogue information, the contents ID cannot be used, in the case of a period of time other than a disclosure period of time.

A contents management server MS also functions as a backup of a contents holding node. For example, when a contents holding node which stores certain contents leaves a system S due to the fact that a power supply is turned off, the number of contents holding nodes is reduced. Thus, in the case where it becomes difficult for a user node to obtain contents, the user node can access a contents management server MS, and obtain the contents. A condition where it is difficult to obtain contents means, for example, a condition where there is no response from a contents holding node, or a condition where a lot of time is necessary.

Further, a user node is also available in a case other than the case where the location of desired contents is retrieved and obtained using contents catalogue information. As mentioned below, a user node can retrieve and obtain the location of desired contents using a Web page obtained based on an access to a Web server WS. In this case, a user node may indicate a contents ID or the title of contents described in the obtained Web page, by a predetermined input means, and retrieve the location of the indicated contents. When a user node browses the obtained Web page, the user node may automatically retrieve the location of contents based on a contents ID or the title of contents described in the Web page.

### [2. Structure and Function of Web Server WS]

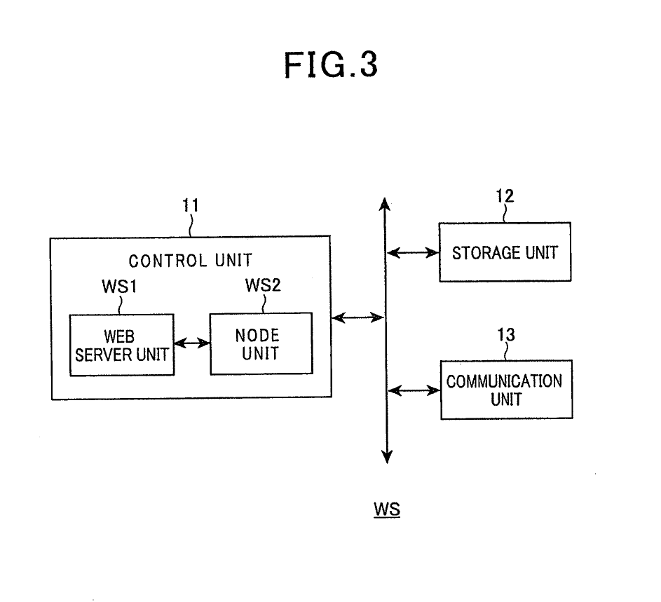

Referring now to FIG. 3, a structure and a function of a Web server WS will be described.

As shown in FIG. 3, a Web server Ws is arranged to include a control unit 11, a storage unit 12, and a communication unit 13. The control unit 11 is composed of a CPU having a calculation function, a RAM, a ROM, and so on. The storage unit 12 is composed of a hard-disc and the like for storing a variety of data, a variety of programs, and so on. The communication unit 13 controls the communication of information with another node Nn and a contents management server MS through a network.

The storage unit 12 stores contents catalogue information, a routing table using a DHT, and so on. The storage unit 12 also stores a server processing program and a node processing program. The server processing program is composed of a Web server program based on Apache or IIS, and a server side program which dynamically creates a Web page.

The control unit 11 functions as a Web server unit WS1 based on the fact that a CPU executes a server processing program stored in the storage unit 12, and so on. The control unit 11 performs a process as a first obtaining device, a second obtaining device, a creating device, a receiving device, a transmission device, a judgment device, a time judgment device, and so on, according to the present invention. The control unit 11 functions as a node unit WS2 based on the fact that a CPU executes a node processing program stored in the storage unit 12 or the like, and performs a process in accordance with a variety of received messages.

Specifically, a node unit WS2 receives a contents updating message including contents catalogue information distributed with a DHT multicast, from a contents management server MS. When the node unit WS2 receives a catalogue updating message, the node unit WS2 obtains contents catalogue information included in the catalogue updating message.

The node unit WS2 updates contents catalogue information already stored in a storage unit 12, to the obtained contents catalogue information. For example, the node unit WS2 add contents attribute information, to contents catalogue information stored in a storage unit 12. Contents attribute information to be added is contents attribute information described in contents catalogue information included in a catalogue updating message. Contents attribute information is, for example, contents attribute information of contents newly introduced.

On the other hand, when a Web server unit WS1 receives a page request of Web page from any of nodes Nn participating in a contents storage system S, the Web server unit WS1 obtains contents attribute information included in contents catalogue information, from a node unit WS2. The Web server unit WS1 creates a Web page in which the obtained contents attribute information is included. The Web server unit WS1 transmits the created Web page to a node Nn which has transmitted a request. For example, in the Web page, a contents ID and the title of contents included in the obtained contents attribute information are inserted.

Here, in a Web page, contents attribute information of contents is inserted. Contents attribute information to be inserted is contents attribute information existing in a disclosure period of time which is available in a contents distributed storage system S. A Web server unit WS1 judges whether the present time is included in a disclosure period of time from the date and time of start of disclosure to the date and time of end of disclosure included in contents attribute information obtained from a node unit WS2. It is desirable that the Web server unit WS1 creates a Web page in which contents attribute information of contents data for which it has been judged that the present time is included in a disclosure period of time is inserted.

Further, it is difficult to insert contents attribute information of all contents available in a contents storage system S. So it is necessary to restrict the number of contents for which contents attribute information is inserted in a Web page. Therefore, for example, it is convenient that contents attribute information of a predetermined number of contents available during a predetermined period of time prior to the present time, a predetermined number of contents having a category handled by a Web page, or the like, is arranged to be inserted in a Web page.

In a control unit 11, one CPU may perform both processes of a web server unit WS1 and a node unit WS2 with multitask or multicore. Further, two CPUs may perform a process of a Web server unit WS1 and a process of a node unit WS2, respectively.

Although a node unit WS2 exchanges a variety of messages with a node Nn, the node unit WS2 is set not to store contents. The reason therefor is as follows: if the node unit WS2 holds contents, the node unit WS2 has to upload contents as a contents holding node in accordance with a request from another node Nn, and this affects the processing of a Web server unit WS1.

### [3. Operation of Web Server WS]

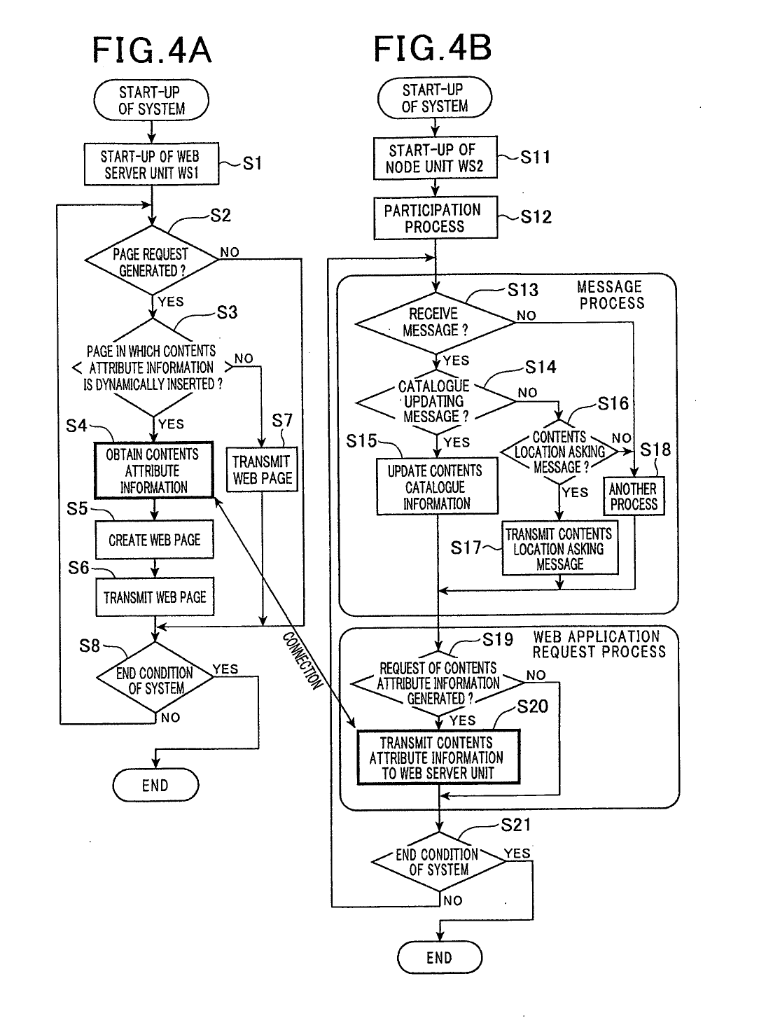

Referring now to FIG. 4, an example of operation of a Web server WS will be described.

A process shown in FIG. 4A is started, for example, by the start-up of system based on the fact that a power supply of a Web server WS is turned on. At step S1, a Web server unit WS1 starts up (step S1).

The Web server unit WS1 judges whether a page request generates at a predetermined cycle (step S2).

On the other hand, a process shown in FIG. 4B is also started, for example, by the start-up of system based on the fact that a power supply of a Web server WS is turned on, and a node unit WS2 starts up (step S11).

The node unit WS2 performs a participating process of participating in a contents distributed storage system S (step S12). In a participating process of step S12, the node unit WS2 is connected to, for example, any node Nn participating in a contents distributed storage systems. The node unit WS2 transmits a participation request message to the connected node Nn. By this process, the node unit WS2 creates a routing table in which a DHT is used, using node information or the like returned from the connected node Nn or the like.

The node unit WS2 judges whether it has received a message transmitted from another node Nn participating in a contents distributed storage system S (step S13). In the case where the node unit WS2 judges that it has received the message (step S13: YES), it moves to step S14. On the other hand, in the case where the node unit WS2 judges that it has not received the message (step S13: NO), it moves to step S19.

In step S14, the node unit WS2 judges whether the received message is a catalogue updating message. In the case where the node unit WS2 judges that it is a catalogue updating message (step S14: YES), it moves to step S15. On the other hand, in the case where the node unit WS2 judges that it is not a catalogue updating message (step S14: NO), it moves to step S16.

In step S15, as mentioned above, the node unit WS2 obtains contents catalogue information included in the received catalogue updating message. The node unit WS2 updates contents catalogue information already stored in a storage unit 12, to the obtained contents catalogue information.

In step S16, the node unit WS2 judges whether the received message is a contents location asking message. In the case where the node unit WS2 judges that it is a contents location asking message (step S16: YES), it moves to step S17. On the other hand, in the case where the node unit WS2 judges that it is not a contents location asking message (step S16: NO), it moves to step S18.

In step S17, the node unit S2 makes reference to a routing table in which a DHT is used, and specifies node information of a node Nn to which a message is to be transmitted. For example, the node unit WS2 specifies node information based on a node ID stored in a routing table and a contents ID included in a contents location asking message. The node unit WS2 is connected to a node Nn in accordance with the specified node information, and transmits a contents location asking message to the node Nn.

In “another process” shown in step S18, a process in the case where a message other than the above message has been received is performed.

In step S19, the node unit WS2 judges whether a request of contents attribute information has generated, i.e., whether there has been a request of contents attribute information from a Web server unit WS1. In the case where the node unit WS2 judges that a request of contents attribute information has generated (step S19: YES), it obtains contents attribute information of predetermined contents from contents catalogue information stored in a storage unit 12. The node unit WS2 transmits the obtained contents attribute information to a Web server unit WS1 (step S20), and moves to step S21. On the other hand, in the case where the node unit WS2 judges that a request of contents attribute information has not generated (step S19: NO), it moves to step S21.

In step S21, the node unit WS2 judges whether it is an end condition of system. In the case where the node unit WS2 judges that it is not an end condition of system (step S21: NO), it returns to step S13. On the other hand, in the case where the node unit WS2 judges that it is an end condition of system (step S21: YES), it terminates the process. For example, it is judged that it is an end condition of system, when there are instructions of turning a power supply off.

On the other hand, in step S2 shown in FIG. 4A, in the case where a Web server unit WS1 has received a page request transmitted from a user node participating in a contents distributed storage system S, it judges that a page request has generated (step S2: YES), and moves to step S3.

In step S3, the Web server unit WS1 judges whether a page to which the page request relates is a page in which contents attribute information is dynamically inserted (embedded). In the case where the Web server unit WS1 judges that it is a page in which contents attribute information is dynamically inserted (step S3: YES), it moves to step S4. On the other hand, in the case where the Web server unit WS1 judges that it is not a page in which contents attribute information is dynamically inserted (step S3: NO), it moves to step S7.

In step S4, the Web server unit WS1 judges whether it can obtain contents attribute information from a node unit WS2 (by a judging device). In the case where the Web server unit WS1 judges that it can obtain contents attribute information, it requests contents attribute information from the node unit WS2. The Web server unit WS1 obtains contents attribute information from the node unit WS2. On the other hand, in the case where the Web server unit WS1 judges that it cannot obtain contents attribute information, it is connected to a contents management server MS or another node Nn, and requests contents attribute information. The Web server unit WS1 obtains contents attribute information from the contents management server MS or a another node Nn. Then, the Web server unit WS1 generates a Web page in which the obtained contents attribute information is inserted (step S5). The Web page is described, for example, in HTML (HyperText Markup Language).

The Web server unit WS1 transmits the generated Web page to a user node which has transmitted the page request (step S6). Thus, the transmitted Web page is received by the user node, and is displayed on a screen by a browser of the user node.

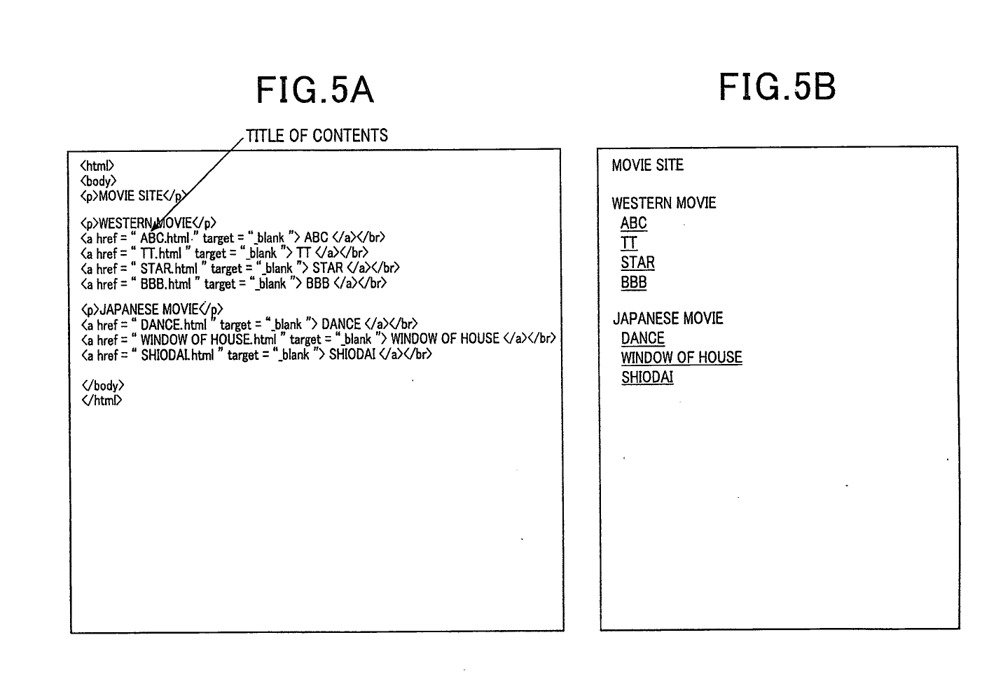

In HTML data shown in FIG. 5A, the titles of contents for seven moving-image contents are inserted or described.

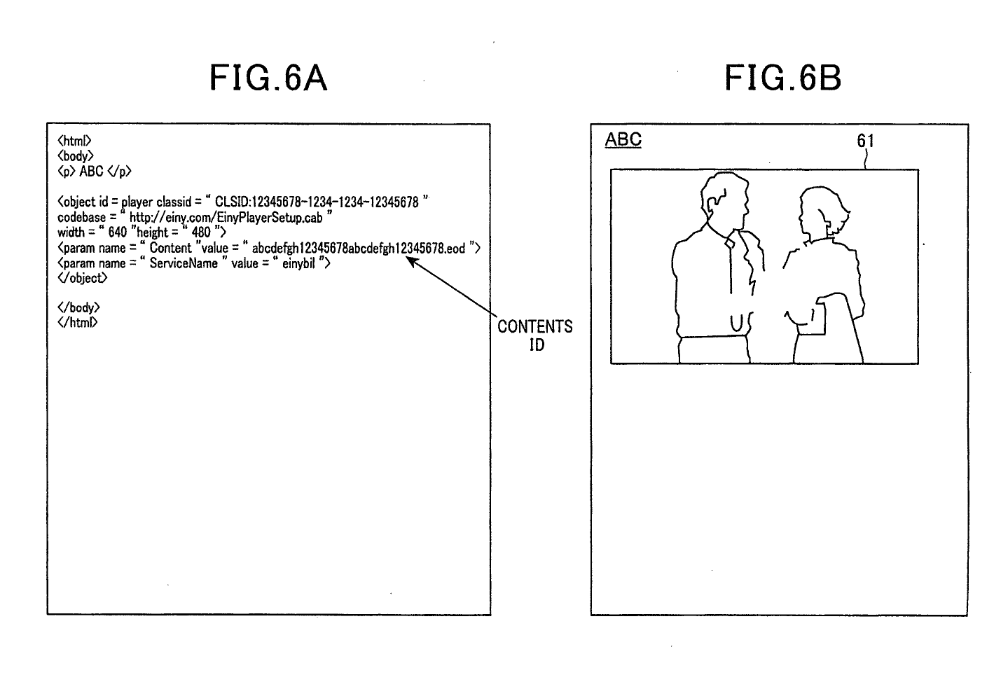

Further, in HTML data shown in FIG. 6A, a contents ID of contents corresponding to the title of contents “ABC” is inserted.

For example, a Web server unit WS1 obtains the title of contents “ABC” and a contents ID “abcdefg - - - ” included in contents catalogue information shown in FIG. 2. At this time, the Web server unit WS1 dynamically inserts “ABC” in HTML data shown in FIG. 5A, and “abcdefg - - - ” in HTML data shown in FIG. 6A, to create a Web page.

When a user node receives a Web page from a Web server WS, the user node displays the Web page, as shown in FIG. 5B. In the case where a user node has selected the title of contents displayed on the Web page, for example, by an inputting device such as a mouse, the user node transmits a contents location asking message to another node Nn. The contents location asking message to be transmitted is a message for retrieving contents corresponding to the selected title of contents. Thus, the user node retrieves the location of the contents, obtains the contents therefrom, and, for example, performs a streaming playback. Thus, the user node displays an image of the contents, for example, in an image display portion 61 on a Web page shown in FIG. 6B, and outputs sound of the contents form a speaker.

On the other hand, in step S7, a web server unit WS1 transmits a web page in which prepared contents attribute information is not inserted, to a node Nn which has transmitted a page request.

In step S8, the Web server unit WS1 judges whether it is an end condition of system. In the case where the Web server unit WS1 has judged that it is not an end condition of system (step S8: NO), it returns to step S2. On the other hand, in the case where the Web server unit WS1 has judged that it is an end condition of system (step S8: YES), the process terminates.

As mentioned above, in accordance with the above embodiment, when a Web server unit WS1 of a Web server WS receives a page request from a user node, the Web server unit WS1 obtains contents attribute information included in contents catalogue information, from a node unit WS2 which has a processing function of a node Nn. The Web server unit WS1 creates a Web page in which contents attribute information is inserted, and transmits it to the user node. Since the embodiment is thus arranged, a Web server WS does not need to obtain contents attribute information directly from a contents management server MS. Therefore, it is possible to dynamically create a Web page for playback of contents, and transmit it to a user node, without losing the lightening of a server load on the contents management server MS. Further, even if a contents management sever MS becomes to a system failure, a Web server WS can quickly create and transmit a Web page in which contents attribute information is inserted, in accordance with a page request from a user node.

In the above embodiment, when a Web server unit WS1 receives a page request from a user node, the Web server unit WS1 obtains contents attribute information included in contents catalogue information, from a node unit WS2. Since the embodiment is thus arranged, it is possible to obtain newer contents attribute information, and insert it in a Web page, as compared with the case where contents attribute information is obtained from a node unit WS2, irrespective of a page request, for example, periodically. The reason therefor is as follows: when contents are newly inserted in a contents distributed storage system S, contents catalogue information which includes contents attribute information of the new contents is distributed from a contents management server MS with a DHT multicast.

A Web server unit WS1 judges whether it is possible to obtain contents attribute information from a node unit WS2. In the case where the Web server unit WS1 has judged that it is not possible to obtain, the Web server unit WS1 obtains contents attribute information from a contents management server MS or another node Nn. The Web server unit WS1 creates a Web page in which the obtained contents attribute information is inserted. Thus, even if a node unit WS2 becomes to a system failure, it is possible to correspond to a page request from a user node.

In processes of steps S4 and S5 shown in FIG. 4A, a Web server unit WS1 obtains contents attribute information in which category information indicative of a category (for example, a contents category and a subcategory shown in FIG. 2) of contents handled by a Web page is included, from a node unit WS2. The Web server unit WS1 creates a Web page in which contents attribute information which corresponds to the category is inserted. The embodiment may be arranged as mentioned above. In accordance with the arrangement, it is possible to effectively reduce an amount of data of Web page, and structure a Web site (a group of Web pages) in which a Web page is effectively arranged. A Web server unit WS1 requests contents attribute information from a node unit WS2. At this time, the Web server unit WS1 indicates a category of contents handled by a Web page. The Web server unit WS1 may be arranged to obtain only contents attribute information corresponding to the category, from a node unit WS2.

In steps S4 and S5 shown in FIG. 4A, a Web server unit WS1 obtains contents attribute information in which information indicative of a disclosure period of time mentioned above is included, from a node unit WS2. The Web server unit WS1 may be arranged to judge whether the present time is included in the disclosure period of time, and create a Web page in which contents attribute information of contents for which it has been judged that the present time is included in the disclosure period of time is inserted. In accordance with the arrangement, it is possible to effectively reduce an amount of data of Web page. A Web server unit WS1 may be arranged to indicate a disclosure period of time in a request of contents attribute information from a node unit WS2. and obtain only contents attribute information of contents corresponding thereto, from a node unit WS2. For example, assuming that a disclosure period of time is from Mar. 30, 2009 to Apr. 28, 2009, a Web server unit WS1 obtains contents attribute information of four contents whose titles are “ABC”, “BBB”, “CCC”, and “DDD” in contents catalogue information shown in FIG. 2.

Further, a Web server unit WS1 may be arranged to create a Web page in which only contents attribute information of contents which have become available a predetermined period of time (for example, one week) prior to the present time is inserted, among contents for which it has been judged that the present time is included in a disclosure period of time. In accordance with the arrangement, it is possible to create a Web page in which contents attribute information of latest contents is preferentially inserted. A Web server unit WS1 may indicate the above prior predetermined period of time in a request of contents attribute information from a node unit WS2. In this case, the Web server unit WS1 may be arranged to obtain only contents attribute information of contents which have become available a predetermined period of time prior to the present time, from a node unit WS2. For example, assuming that a Web server unit WS1 indicates a predetermined period of time (for example, one week) prior to the present time (for example, Mar. 18, 2009), contents attribute information of two contents whose titles are “BBB”, and “CCC” is obtained in contents catalogue information shown in FIG. 2.

In the above embodiment, a Web server WS is arranged to have a node unit WS2 (i.e., resident). However, it may be possible that the other terminal is prepared, the other terminal has a node unit WS2, and the other terminal and a Web server WS communicate information with each other.

Further, it may be possible that a contents management server MS and a Web server WS are integrated with each other. An explanation has been given on the assumption that a contents distributed storage system S according to the above embodiment is formed based on an algorithm in which a DHT is utilized. However, the present invention is not limited to this arrangement. As a system other than a contents distributed storage system in which a DHT is utilized, there is a contents distributed storage system of a so-called hybrid method. In case of a contents distributed storage system S of a hybrid method, the locations of contents are managed by a predetermined server device. In this case, each node Nn asks a server device about the locations of contents directly.

The present invention is not confined to the configuration listed in the foregoing embodiments, but it is easily understood that the person skilled in the art can modify such configurations into various other modes, within the scope of the present invention described in the claims.

What is claimed is:

1. A server device which can communicate with a node device in a contents distributed storage system in which a plurality of contents data are distributed and stored in a plurality of node devices which can communicate with each other through a network, and in which each node device stores contents attribute information necessary for retrieving the locations of the contents data,
the server device comprising:
a storage device configured to store contents attribute information obtained from a predetermined device which stores the contents attribute information,
a creating device configured to create a Web page in which the contents attribute information stored in the storage device is inserted,
a receiving device configured to receive a page request of a Web page from any of the node devices, and
a transmission device configured to transmit the Web page created by the creating device, to the node device which has transmitted the request, based on the page request by the receiving device.

2. A server device according to claim 1, further comprising:
a first obtaining device configured to obtain the contents attribute information from the storage device, and
a judgment device configured to judge whether it is possible to obtain the contents attribute information from the storage device,
wherein in the case where the judgment device has judged that it is not possible to obtain, the first obtaining device obtains the contents attribute information, from a plurality of the node devices, a contents management server which manages a plurality of the contents data, or the node device.

3. A server device according to claim 1, further comprising:
a second obtaining device configured to obtain the contents attribute information distributed from the predetermined device when a contents data has been newly inserted in the contents distributed storage system,
wherein the storage device stores contents attribute information obtained by the second obtaining device, and
the creating device creates the Web page when the page request has been received by the receiving device.

4. A server device according to claim 1,
wherein the storage device stores the contents attribute information which includes category information indicative of a category of the contents data handled by the Web page, and
the creating device creates a Web page in which the contents attribute information corresponding to the category is inserted.

5. A server device according to claim 1,
wherein the storage device stores the contents attribute information which includes information indicative of a disclosure period of time during which the contents data is available in the contents distributed storage system,
the server device further comprising a time judgment device configured to judge whether the present time is included in the disclosure period of time, and
wherein the creating device creates a Web page in which the contents attribute information of the contents data for which the time judgment device has judged that the present time is included in the disclosure period of time is inserted.

6. A server device according to claim 5,
wherein the creating device creates a Web page in which the contents attribute information of contents data which have become available a predetermined period of time prior to the present time is inserted, the inserted attribute information is determined among the contents data for which the time judgment device has judged that the present time is included in the disclosure period of time.

7. A computer-readable recording medium in which a server processing program for making a computer function as a server device according to claim 1 is recorded.

8. A Web page creating method in a contents distributed storage system in which a plurality of contents data are distributed and stored in a plurality of node devices which can communicate with each other through a network, and in which each node device stores contents attribute information necessary for retrieving the locations of the contents data,
the method including steps, the steps comprising:
storing, in a storage device, contents attribute information obtained from a predetermined device which stores the contents attribute information,
causing a server device to create a Web page in which the contents attribute information stored in the storage device is inserted,
causing the server device to receive a page request of a Web page from any of the node devices, and
causing the server device to transmit the created Web page, to a node device which has transmitted the page request, in accordance with the received page request.

9. A computer-readable recording medium recording a program to be performed, in a contents distributed storage system in which a server device can communicate with a node device, in which a plurality of contents data are distributed and stored in a plurality of node devices which can communicate with each other through a network, and in which each node device stores contents attribute information necessary for retrieving the locations of the contents data, the program comprising steps of:
storing, in a storage device, contents attribute information obtained from a predetermined device which stores the contents attribute information,
causing the server device to create a Web page in which the contents attribute information stored in the storage device is inserted,
causing the server device to receive a page request of a Web page from any of the node devices, and
causing the server device to transmit the created Web page, to a node device which has transmitted the page request, in accordance with the page request received in the receiving process.

10. A contents distributed storage system in which a plurality of contents data are distributed and stored in a plurality of node devices which can communicate with each other through a network, and in which each node device stores contents attribute information necessary for retrieving the locations of the contents data,
the system comprising a server device which can communicate with the node devices,
the server device comprising:
a storing device configured to store contents attribute information obtained from a predetermined device which stores the contents attribute information,
a creating device configured to create a Web page in which the contents attribute information stored in the storage device is inserted,
a receiving device configured to receive a page request of a Web page from any of the node devices, and
a transmission device configured to transmit the Web page created by the creating device, to the node device which has transmitted the request, based on the page request received by the receiving device, and
the node device which transmits the page request of the Web page comprising:
a display device configured to receive the Web page, and display the received Web page, and
a retrieval query transmission device configured to transmit a retrieval query for retrieving contents data corresponding to the title of contents included in the contents attribute information and displayed on the Web page, to any of the other node devices.
